(19) United States
(12) Patent Application Publication
(10) Pub. No.: US 2018/0354115 A1
(43) Pub. Date: Dec. 13, 2018

(54) Multipurpose Ratcheting Chainsaw Scrench Tool

(71) Applicant: Bill Jason Chambers, Vancouver, WA (US)

(72) Inventor: Bill Jason Chambers, Vancouver, WA (US)

(21) Appl. No.: 15/619,417

(22) Filed: Jun. 9, 2017

(51) Int. Cl. B25F 1/00; B25B 13/46; B25B 15/00; B25B 13/48

(52) U.S. Cl. CPC B25F 1/00; B25B 13/483; B25B 15/007; B25B 13/463

(57) ABSTRACT

The present invention is a ratcheting scrench, which allows for quick and easy removal of bolts, spark plugs, and nuts. The core components of the invention are a bolt and spark plug removing end separated by a ratcheting mechanism and a nut removing end. The invention can be used to remove bolts and spark plugs without requiring removal of the device from the tool which bolts are being removed from.

### FIELD OF THE DISCLOSURE

This disclosure relates generally to the field of chainsaw maintenance tools.

### BACKGROUND

Currently there are a number of solutions for removing nuts, screws, and sparkplugs from chainsaws. Some of these solutions attempt to combine various tools into one compact tool, but these solutions fail to meet the needs of the industry because they still require tool removal and reattachment especially when bolts or sparkplugs are removed. Other solutions attempt to eliminate the need for tool removal when removing or reattaching bolts by using various ratcheting mechanisms but these solutions are similarly unable to meet the needs of the industry because they require the use of a separate tool for removal of screws.

It would be desirable to have a chainsaw repair tool that allows for quick, and efficient removal of bolts, spark plugs, and screws. Furthermore, it would also be desirable to have a chainsaw repair tool that did not need to be removed and reattached when the maximum amount of circular movement in the desired direction is reached. Therefore, there currently exists a need in the industry for a ratcheting scrench.

### SUMMARY

The disclosure presented herein relates to a ratcheting scrench. The preceding and following embodiments and descriptions are for illustrative purposes only and are not intended to limit the scope of this disclosure. Other aspects and advantages of this disclosure will become apparent from the following detailed description.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The disclosed device is unique when compared with other known devices and solutions because it provides the ability to remove sparkplugs and bolts without removing and reattaching the tool once the maximum amount of circular movement in the desired direction is reached. Furthermore, the device allows the removal and reattachment of bolts, screws, and sparkplugs without the necessity of carrying around multiple tools saving chainsaw users both time and money.

The disclosed device is unique in that it is structurally different from other known devices or solutions. More specifically, the device is unique due to the presence of: (1) a ratcheting mechanism; (2) a spark plug and bolt removing mechanism; and (3) a screw removing mechanism all in one device.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 shows a slightly downward perspective view of a ratcheting scrench.

FIG. 2 shows a head on view of the nut and bolt removing end of the ratcheting scrench.

FIG. 3 shows a side view of the ratcheting scrench.

FIG. 4 shows a slightly upward perspective view of a ratcheting scrench.

FIG. 5 shows a perspective view of the ratcheting scrench lying on its side.

FIG. 6 shows a slightly exploded view of the nut and bolt removing end of the ratcheting scrench focusing on the ratcheting mechanism.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Disclosed is a ratcheting scrench, which is made up of the following components: (1) an elongating shaft, (2) a nut and spark plug removing end, and (3) a screw removing end. The nut and spark plug removing end is further made up of (1) a socket designed to fit nuts, (2) a socket designed to fit spark plugs and (3) a ratcheting mechanism.

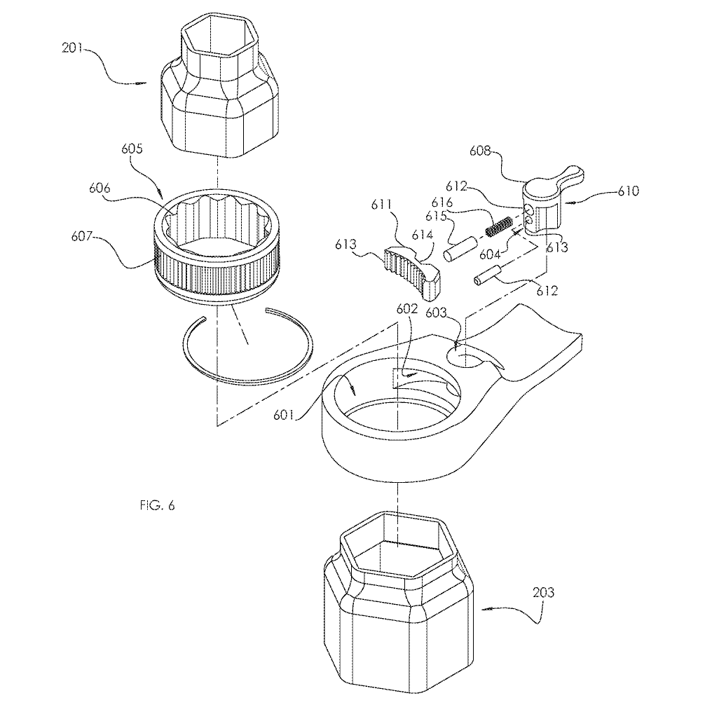

As can be seen in FIG. 1, elongating shaft 101 extends between spark plug and nut removing end 103 and screw removing end 105. Elongating shaft 101 has a circular cross section in FIGS. 1 through 6, but, as would be obvious to those skilled in the art, noncircular cross sections are possible without straying from the spirit of the invention. Screw removing end 105 in FIGS. 1 through 6 is a blade extending outwardly from shaft 101 opposite from the nut and spark plug removing end 103. The blade consists of two flat surfaces that depend from the elongating shaft at a slight angle to the central axis of the elongating shaft. These flat surfaces end in a thin straight edge disposed normal to the central axis of the elongating shaft. However, screw removing end 105 can be any mechanism capable of interacting with and removing screws. Use of Phillip's Tri-Wing, or Torx heads, for example, would not stray from the spirit of the invention.

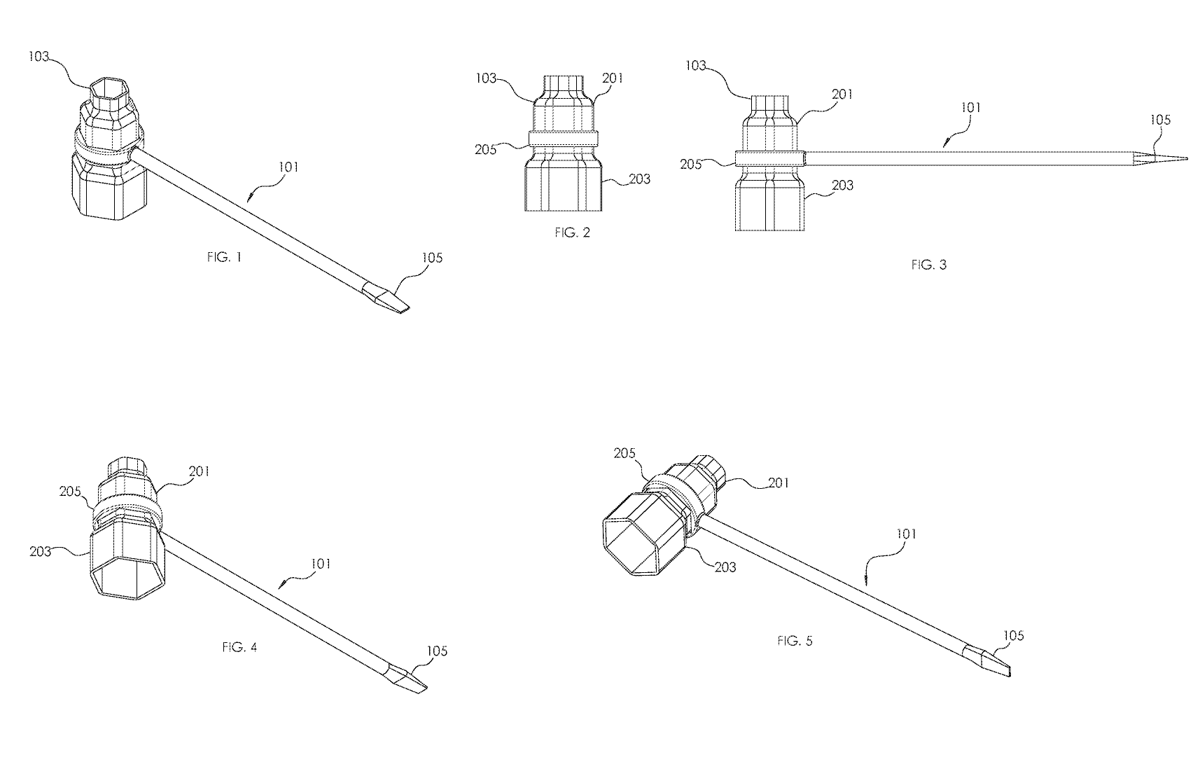

As can be seen in FIG. 2, nut and spark plug removing end 103 consists of two elongated tubular bodies 201 and 203 extending in opposite directions out of ratcheting mechanism 205. As can be seen in FIGS. 3 through 5, the central axis of tubular bodies 201 and 203 is generally perpendicular to the central axis of elongating shaft 101. Both tubular bodies 201 and 203 comprise walls generally flat and parallel to the central axis of the tube that connect to form the tubular body. In FIGS. 1 through 5 tubular end 201 decreases in radius as it extends away from ratcheting mechanism 205. Likewise, tubular body 203 increases in radius as it extends away from ratcheting mechanism 205. As would be obvious to those skilled in the art, other configurations are possible. The only requirement is that one tubular body is capable of securely gripping a bolt while the other is capable of securely griping a sparkplug.

Tubular bodies 201 and 203 can be various lengths but preferably allow the head of the bolt to extend into ratcheting mechanism 205. Various ratcheting mechanisms known in the art would work with the invention. In one embodiment, shown in FIG. 6, ratcheting mechanism 205 comprises opening 601 which sits between tubular bodies 201 and 203. Within opening 601 sits recessed opening 602 which extends toward screw removing end 105. Opening 603 connects recessed opening 602 with the outside of the device. An arcuate abutment wall in opening 603 faces recessed opening 602. A driving member 605 mounted in receiving space 601 rotates parallel to an axis parallel to elongating shaft 101. The driving portion 606 of driving member 605 is adapted to directly or indirectly drive a fastener and has a plurality of protrusions and recessed portions. The outer periphery of driving portion 606 includes annular teeth 607. A switch button 608 with a first side 609 and a second side 610 and rotatable about an axis parallel to elongating shaft 101 sits in opening 603. First side 609 of switch button 608 is intermediate pawl 611 and second side 610 of switch button 608. A pressing member receptacle 612 and a fixing member receptacle 613 sits in-between the first side 609 and second side 610 of switch button 608.

Pawl 611 sits in recessed opening 603 between driving member 605 and switch button 608 and includes toothed portion 613 and a recessed portion 614. Toothed portion 613 can reversibly engage with driving member 605.

Pressing member 615 biased by elastic member 616 is received in pressing member receptacle 612. The first end of pressing member 615 biased by elastic element 616 fits into recessed portion 614 of pawl 610 which causes the toothed portion 613 of pawl 610 and the exterior toothed portion 607 of driving portion 606 to engage. Received into fixing member receptacle 613 is fixing member 617 which can press against the pawl if the pawl malfunctions. Switch button 608, part of which protrudes outside of tubular members 201 and 203 can be pivoted relative to elongating shaft 101 to change the driving direction and non-driving direction of ratcheting mechanism 205. Specifically when elongating shaft 101 is rotated in the driving direction a fastener coupled with driving portion 606 of driving member 605 rotates jointly with elongating shaft 101 in the driving direction. When elongating shaft 101 is rotated in the non-driving direction the fastener and driving member 605 remain still.

While preferred and alternate embodiments have been illustrated and described, as noted above, many changes can be made without departing from the spirit and scope of the ratcheting scrench. Accordingly, the scope of the ratcheting scrench is not limited by the disclosure of these preferred and alternate embodiments. Instead, the scope of the invention is to be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶6. In particular, the use of “step of” in the claims herein is not intended to invoke the provisions of U.S.C. § 112 ¶ 6.

We claim:

1. A device comprising:
a tubular shaft with a first and a second end;
a nut removing apparatus located at the first end;
a ratcheting apparatus located at the second end;
a first body attached to the ratcheting apparatus having a recess extending therein on an
axis generally normal to the central axis of the tubular shaft, the recess forming a wall having a plurality of interconnected flat segments disposed generally parallel to said access of the recess.

2. The device as in claim 1 further comprising a second body attached to the ratcheting apparatus having a recess extending therein on an axis generally normal to the central axis of the tubular shaft, the recess forming a wall having a plurality of interconnected flat segments disposed generally parallel to said access of the recess.

3. The device as in claim 2 wherein a switch reverses the ratcheting mechanism's driving direction.

4. The device as in claim 3 wherein the first and second body generally form a 180 degree angle.

5. The device as in claim 4 wherein the radius of the first body generally increases as it extends on an axis generally normal to the central axis of the tubular shaft and the radius of the second body generally decreases as it extends on an axis generally normal to the central axis of the tubular shaft.

6. The device as in claim 5 wherein the first body forms a recess capable of engaging a nut.

7. The device as in claim 6 wherein the second body forms a recess capable of engaging a spark plug.

8. The device as in claim 7 wherein the nut removing apparatus located at the first end is a blade with a central linear axis disposed coaxially with the shaft, said blade having confronting flat surfaces that depend toward each other forming a thin straight edge.

9. The device as in claim 7 wherein the first body forms a recess capable of engaging a chainsaw cover plate securing nut, and the second body forms a recess capable of engaging a chainsaw spark plug.

10. A device comprising:
a tubular shaft with a first and second end;
a blade with a central linear axis disposed coaxially with the shaft, said blade having confronting flat surfaces that depend toward each other forming a thin straight edge;
a ratcheting apparatus located at the second end;
two bodies attached to the ratcheting apparatus generally forming a 180 degree angle with respect to each other and the bodies having a recess extending therein on an axis generally normal to the central axis of the tubular shaft, the recess forming a wall having a plurality of interconnected flat segments disposed generally parallel to said access of the recess;
the first body forming a recess capable of engaging a chainsaw cover plate
securing nut, and the second body forming a recess capable of engaging a chainsaw spark plug.
